(19) United States
(12) Patent Application Publication
(10) Pub. No.: US 2010/0166926 A1
(43) Pub. Date: Jul. 1, 2010

(54) SPENT HOP PRODUCTS, THEIR CONTENT IN STILBENES AND THEIR USE AS ANTIOXIDANT FOR COMESTIBLE PRODUCTION

(76) Inventors: Vesna Jerkovic, Nivelles (BE); Sonia Colin, Suarlee (BE)

Correspondence Address: Levy & Grandinetti, P.O. Box 18385, Washington, DC, 20036, US

(21) Appl. No.: 12/448,111

(22) PCT Filed: Dec. 7, 2007
(86) PCT No.: PCT/EP2007/063558

§ 371 Date: Dec. 14, 2009

(30) Foreign Application Priority Data
Dec. 7, 2006 (EP) EP 06125587.3

(51) Int. Cl. C12H 1/14

(52) U.S. Cl. 426/271

(57) ABSTRACT

A method of producing a comestible by adding spent hop material during the production of the comestible, wherein the stilbenes and flavanoids contained in the spent hop material act as quenchers of oxygen resulting in an improved flavor stability of the comestible, and wherein the surviving stilbenes present in the comestible provide additional anti-oxidative properties to the comestible, leading to health benefits for the consumer.

### FIELD OF THE INVENTION

The present invention generally relates to adding stilbenes and flavanoids to comestible (e.g. beverages). More particularly, it relates to a novel method of using spent hop material for the fabrication of a beverage, with specific anti-oxidative properties.

### BACKGROUND OF THE INVENTION

The cultivated hop (Humulus Lupulus L.) is a dioecious plant of the Cannabinaceae family (order Urticales), almost exclusively used for the brewing industry.

Hops contain hundreds of different groups of organic compounds, however the major components present in hop are hereafter presented in % w/w:

| | |
|---|---|
| Hop resins: | 4-27, |
| Essential oil: | 0.5-3.0 |
| Hop polyphenols and tannins: | 3-6 |
| Monosaccharides: | 2 |
| Amino acids | 0.1 |
| Proteins | 15 |
| Lipids and fatty acids | 1-5 |
| Pectins | 2 |
| Ash-salts | 10 |
| Cellulose-lignins | 40-50 |
| Water | 8-12 |

Of particular interest for the brewing industry, are the so-called soft-resins (containing mainly α-acids and β-acids), hop oils and polyphenols. These three classes are very important from a brewing point of view and are also used to differentiate hop varieties (see FIG. 1).

Although hop polyphenols have been widely studied in the last decade for their antioxidant activity in the boiling kettle, very little is yet known about their real impact on health. The recent discovery of resveratrol in hops highlights what may be the key role of hop in producing the health benefits of moderate beer consumption. Resveratrol and its glycoside(piceid) can be found in cis (2) or trans (1) configurations (see FIG. 2). Already known as a potent antioxidant, trans-resveratrol has also been investigated for some interesting physiological effects, including anti-platelet, anti-inflammatory, estrogenic, cardioprotective, anti-tumor, and anti-viral properties. Although less potent than its aglycon, trans-piceid would appear to limit the elevation of lipid concentration and to inhibit eicosanoid synthesis. In 2003, Callemien et al. mentioned for the first time the presence of stilbenes in hops (total concentration close to 3.5 ppm). Recently, Jerkovic et al. compared various hop pellets from harvest 2003. In this case the total stilbene concentration ranged from 5 to 16 ppm, trans-piceid being in all cases the major constituent. Except for very highly oxygen-sensitive varieties, it appeared that the lower the α-acid content, the higher the resveratrol potential.

Hop products (cones, pellets or extracts) contain no or very little bitter compounds but mainly precursors of the bitter compounds. In order to communicate the expected bitterness to the future beer, hop products should be added as raw material during the brewing process.

The most important chemical conversion occurring during wort boiling is the thermal isomerisation of the α-acids to the iso-α-acids, via an acyloin-type ring contraction (see FIG. 3).

The iso-α-acids have an intensive bitter taste and although rather labile, they survive the boiling process. The iso-α-acids are vulnerable to oxidation, leading to the formation of a large number of oxidized derivatives during the wort boiling, which can adversely affect beer flavour.

Volatile components of the hop oils are evaporated during the boiling process, when hops are added at the start of the boil. Essential oils are very sensitive to oxidation, and low-molecular-weight compounds may be oxidized, thereby decreasing the volatility and increasing the solubility in hot wort. In order to keep a significant fraction of the hop oils in the wort, the hop is preferably added later in the boiling wort, leading to a poor extraction of α-acids, and therefore to low bitterness. The present tendency in the utilization of hop is to add the bitter variety very early during the boiling process and the aromatic variety later in the process in function of the desired hop aroma.

Hop extraction as a means of concentrating α-acid and essential oils of hop is not a recent process and organic solvents, such as ethanol, dicloromethane, benzene, methanol, hexane and trichloroethylene, have been successfully employed. Today, liquid and supercritical carbon dioxide are the most efficient apolar solvents for extracting α-humulones, and to produce extract containing a high proportion of α-acid (27-55% in the supercritical CO₂ extract and 30-60% in the liquid CO₂ extract). The latter is a cleaner product, containing no chemicals like pesticides, no hard resins, no chlorophylls, and very little polyphenols. CO₂ hop extracts are often standardized to a given α-acid concentration, by adding sugar syrup, thus facilitating the utilization in the brewhouse. After the extraction process, the residual organic material is a waste product, which is generally presented under the form of pellets, also called spent hop pellets.

Nowadays spent hop pellets are generally eliminated and there is rare valorization technique for the brewing industry or for other alternative industries. Miller Brewing Company, disclosed in a US Patent Application PCT/US96/07325 a method of preparing a full hop flavored beverage using spent hop or an extract of the spent hop. It is a object of this patent application to valorize spent hop for industry to this end, the invention provides a method for manufacturing a comestible product comprising the steps of :

adding a spent hop material to said comestible product

quenching oxygen

It has been surprisingly discovered, that spent hop pellets, constitute a rich source of stilbenes(phytoalexins), which are recognized to have particular anti-oxidative properties.

Stilbenes, in particular resveratrol and its glucoside(piceid), are widely reported to be beneficial to health, with some effects such as anti-cancer, anti-viral, neuroprotective, anti-aging, and anti-inflammatory effects.

The major dietary sources of stilbene include grapes, red wine, peanuts, cocoa and soy; however, they can also be introduced into the diet through Itadori tea. Recently (2005), V. Jerkovic, D. Callemien and S. Collin have identified the presence of stilbenes (trans-piceid, cis-piceid, and trans-resveratrol) in hop, with a concentration ranging from 5 to 16 ppm.

The levels of trans-piceid (6), cis-piceid (7), and trans-resveratrol (8) detected in spent hop are very interesting (see FIG. 4).

Advantageously, said spent hop material is chosen in the group consisting of a residual fraction of the hop extraction, in whole or in part, a residual fraction of the soft resins extraction and a residual fraction of the hopoils extraction, a liquid extract of spent hop or a solid extract of spent hop.

Spent hop is the residual fraction generated after the extraction of hop, in whole or in part, of soft resins (e.g. α-acids and β-acids) and hop oils. Nowadays, spent hop materials are generally eliminated and there is rare valorization technique for the brewing industry or for other alternative industries. Spent hop thus emerges as a very promising, cheap, delipidated raw material for the production of a resveratrol-enriched comestible.

The method of producing a comestible, which is covered by this invention, includes the use of all different types of spent hop residues, available after the extraction process, including any form of extract derived from any form of spent hop residue. Moreover, this invention includes the anti-oxidative agent used for the production of a comestible, which comprises a natural extract obtained from spent hop residue. By extracts obtained from spent hop residues, this invention includes as well liquid extracts and solid extracts. In a particular embodiment, the liquid extract of spent hop containing stilbenes and flavonoid compound are extracted in a liquid phase of an extraction with a polar solvent selected from the group consisting of water, ethanol, isopropanol, methanol, dichloromethane, trichloromethane, n-butanol, ethyl acetate, ethylene dichloride, trichloroethylene, and mixture thereof. Liquid extract can be produced by any extraction method, which uses any polar solvant. Preferably, the polar solvant is preferably water, ethanol and mixture thereof. In still another embodiment, the solid extract of spent hop comprises the solid residues of said extraction and solid extract includes any suitable dry form of the extract, which can be dry formulations such as powder, tab or the like. Preferably, the hop is chosen in the group consisting of hops having a low level of soft resins, pellets produced from hop having a low level of soft resins, enriched type thereof. Surprisingly, the most interesting hop varieties used for the extraction of stilbenes contains generally a low level of α-acids, which makes this invention particularly interesting for the valorisation of the spent hop material obtained from “aromatic” hop varieties.

This invention covers the method of producing any type of comestible, and is applicable for solid and liquid products, which can be a food or a beverage. In a preferred embodiment, this invention describe the method of producing a beverage, such as beer, by adding spent hop material during the production of the beverage, wherein the stilbenes and flavanoids contained in the spent hop material act as quenchers of oxygen during the post addition process, resulting in an improved flavor stability of the beverage, and wherein the surviving stilbenes present in the beverage provide additional anti-oxidative properties to the beverage, leading to health benefits for the consumer. A preferred time of adding spent hop material during the hot process, is very late during the boiling process or after the boiling step before the cooling of the wort. An optimal combination is therefore obtained with a good extraction of stilbenes and limited loses by oxidation. When the production of the anti-oxidative beverage comprises a fermentation step, it can be advantageous to add the spent hop material during or after the fermentation process. When the process of production includes a maturation stage the addition will preferably be done during that phase, which improve the extraction yield of the stilbenes and decrease the stilbene losses. For the production of a clear beer, the addition of spent hop material will preferably be done before the final filtration of the beverage, in order to provide the visual aspect and the stability of the delivered beverage to the consumer.

### DRAWINGS

Appended hereto are FIGS. 1 to 5 of the drawings, in which:

FIG. 1 is a schematic overview of the different important components of hops

FIG. 2. is a chemical representation of the two isomers of the resveratrol compound: trans-resveratrol (1) and cis-reveratrol (2).

FIG. 3 is the chemical reaction of isomerisation of α-acids to iso-α-acids: humulones (3) is isomerised to trans-iso-humulone (4) and cis-iso-humulone (5).

FIG. 4 is a chromatogram (RP-HPLC-APCI(+)/MS-MS) data for a spent from the Tomahawk hop CO₂ extraction. MS/MS chromatogram (m/z=229) of trans-piceid (6), cis-piceid (7), and trans-resveratrol (8).

FIG. 5. is the representation of the concentration (mg/kg) of trans-piceid, cis-piceid (expressed in trans-piceid equivalents), and trans-resveratrol in spents from hop CO₂ extraction.

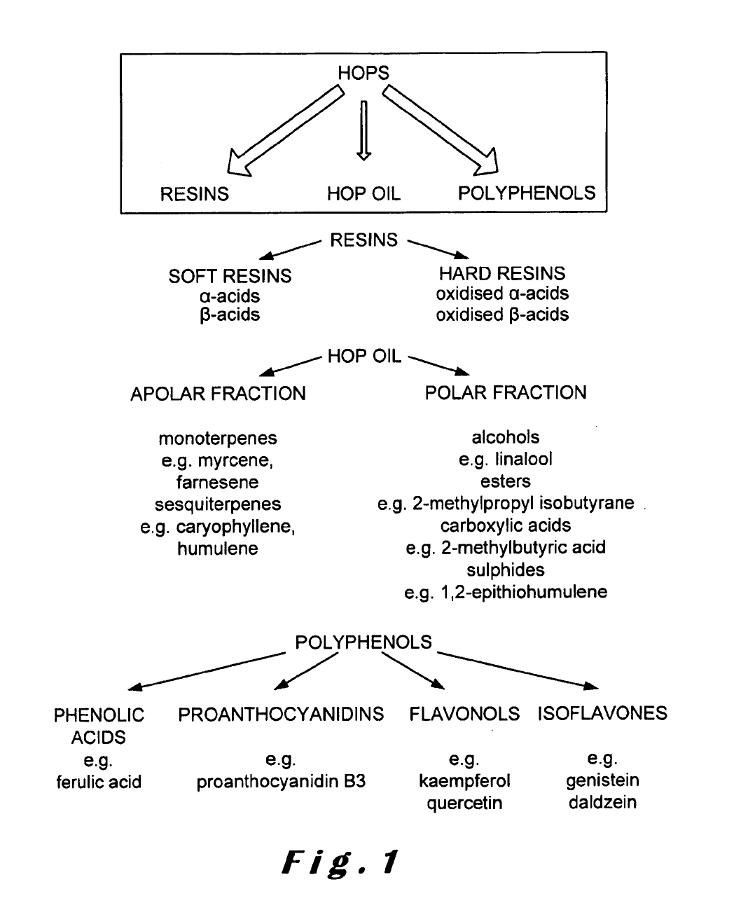

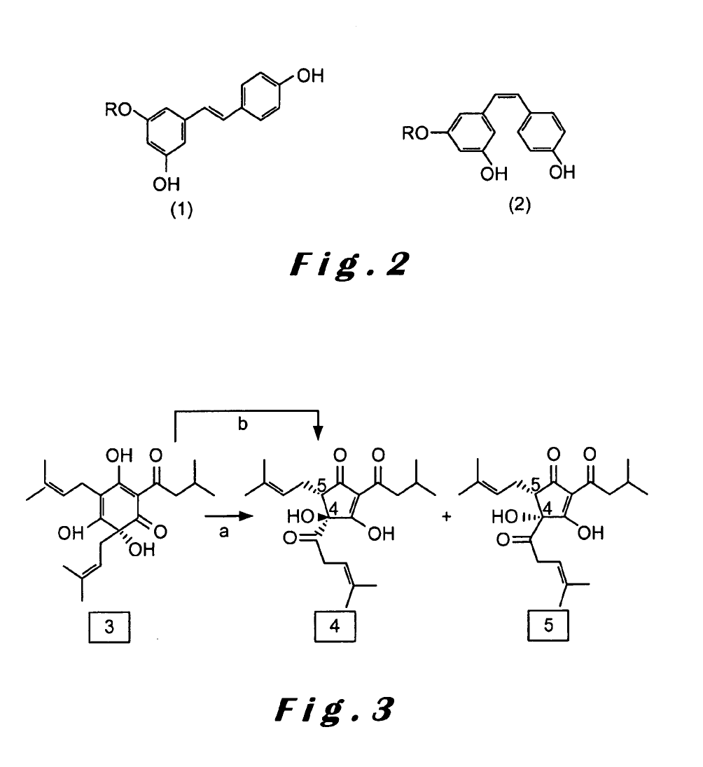

### DETAILED DESCRIPTION OF THE INVENTION

This invention provides a novel and advantageous method of producing a comestible by adding spent hop material during the production of the comestible, wherein the stilbenes contained in the spent hop material act as quenchers of oxygen during the post addition process, resulting in an improved flavor stability of the comestible, and wherein the surviving stilbenes present in the comestible provide additional anti-oxidative properties to the comestible, leading to health benefits for the consumer.

The relative stilbene concentrations in pellets derived from six cultivars of hop were analyzed. Although low-bitterness cultivars were confirmed to be the most interesting cultivars, they displayed in some cases very different concentrations. Cultivars with the highest amounts of free trans-resveratrol (e.g. Nugget with 1 mg/kg) did not turn out to be the most interesting sources of total stilbens (e.g. Sterling with only 0.35 mg/kg trans-resveratrol but 14.79 mg/kg total stilbenes). On the other hand, cis-resveratrol was absent from all nine hop samples. Pelletization induced strong stilbene degradation in some sensitive cultivars (>56% Willamette or Tomahawk), whereas other varieties (Warrior or Nugget) proved much more resistant. Surprisingly, glycoside forms seemed to be more abundantly lost.

Some complementary analyses were performed on the extract obtained from hop. Hop extracts constitute with hop cones and hop pellets, a frequent source of α-acid used in the brewing industry. Such extraction is used to separate desirable hop material from cellulosic material. Many solvents such as ethanol, dicloromethane, benzene, methanol, hexane and trichloroethylene, have been successfully used for this purpose, and today's solvents are chosen on the basis of selectivity (solubility of desirable hop components), safety, environmental standards, boiling point and cost. Water is not used since the solubility of hop components in water is too low. Carbon dioxide, ethanol and hexane are the common solvents used at present. There is a principal difference between the solvents ethanol, hexane and carbon dioxide. Ethanol can be mixed with water and consequently has a polar character. Hexane, however, hardly dissolves water and can thus be classified as a non-polar solvent. The polarity of carbon dioxide is adapted by the operating conditions of temperature and pressure. These experiments were conducted on carbon dioxide extract. Due to the high hydrophobicity of carbon dioxide, the analyzed supercritical hop extracts contained no stilbenes although more apolar than hop flavonoids, also recovered in low amount in such extracts. The residual fraction of hop after the extraction process is generally considered as a waste product without value, as it contains no or trace of soft resins, with no or very little bittering potential.

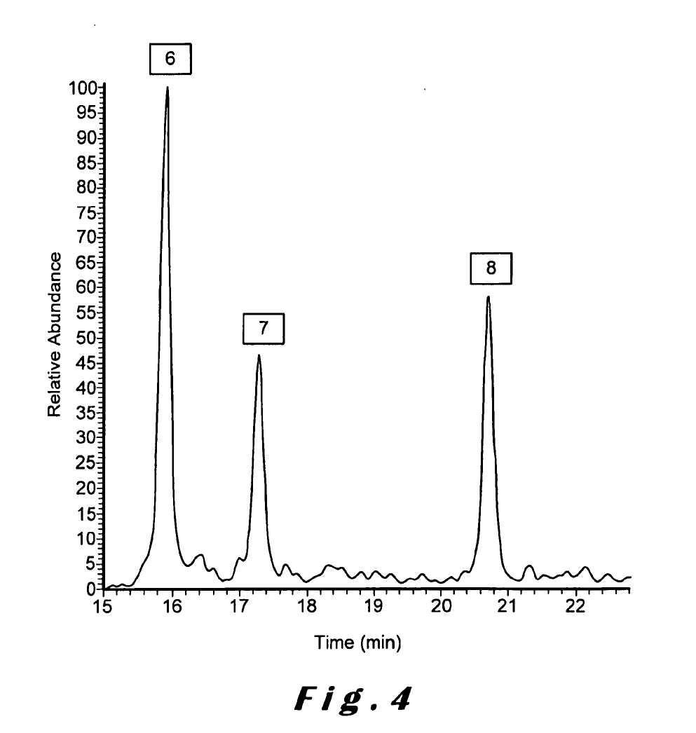

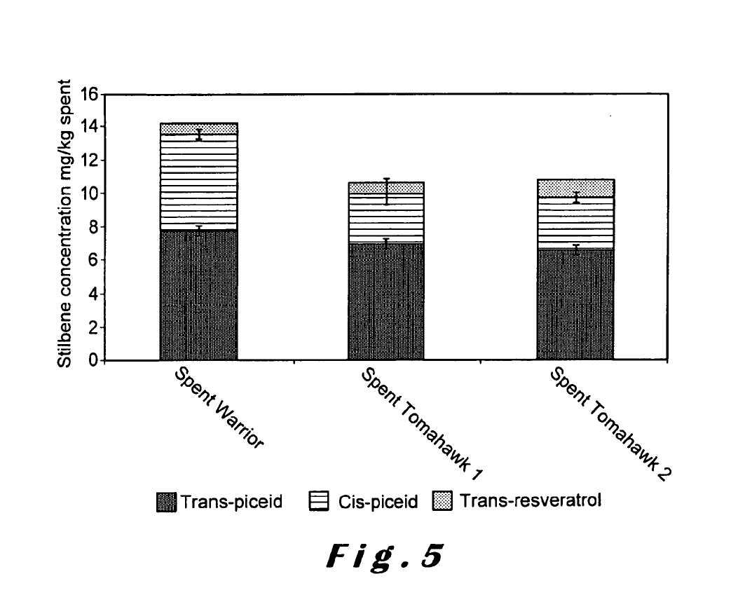

As stilbene compounds were identified in fresh hops, in cones or in pellets, but not in supercritical carbon dioxide extract, it has been thought that they might be still present in the spent hop fraction, also called in this invention residual fraction. Some analytical experiments were conducted on spent hop pellets, the residual fraction obtained after the extraction of soft resins (e.g. α-acids and β-acids) and hop oils. The levels of trans-piceid (6), cis-piceid (7), and trans-resveratrol (8) detected in spent hop are very interesting (see FIG. 4). The level of trans-piceid, cis-piceid, and trans-resveratrol reached respectively 7 mg/kg, 6 mg/kg, and 0.6 mg/kg in the Warrior sample (see FIG. 5). Spent hop thus emerges as a very promising, cheap, delipidated raw material used for the production of comestible with advantageous properties.

The method of producing a comestible presented in this invention uses some spent hop material that is the residual fraction generated after the extraction of hop, in whole or in part, of soft resins (e.g. α-acids and β-acids) and hop oils, as it is described in the background of this invention. This fraction is generally presented under the form of pellets. However, it is to be understood that this invention is not limited to the use of spent hop pellets, but also covers the use of different types of spent hop residues, available after the extraction process. Moreover, this invention includes the use of any form of extract derived from any form of spent hop residue, what we refer to spent hop material. By extracts obtained from spent hop residues, this invention includes as well liquid extracts and solid extracts. Liquid extract can be produced by any extraction method, which uses any polar solvent. Some extraction have already been obtained by using polar solvent selected from the group consisting of water, ethanol, isopropanol, methanol, dichloromethane, trichloromethane, n-butanol, ethyl acetate, ethylene dichloride, trichloroethylene, and mixture thereof. The extraction can easily be obtained with a mixture of ethanol and water in any combination. Adequate extraction can be obtained with the ethanol/water ratio of 80/20 (v/v). The temperature during the extraction is an important parameter and can impact positively by reducing the extraction time, required to fulfill the extraction of stilbenes. The optimum extraction conditions are obtainable when the temperature is maintained at 60° C. during 30 min. The insoluble fraction is eliminated and the liquid fraction can be concentrated for further use. The liquid extract obtained from the spent hop residue can be dried by using a separation technique (e.g. evaporation, distillation, lyophilisation), which allows the separation between the solid material and the polar solvent. The solid fraction will contain the active compounds, and will be concentrated in stilbenes for further use. The advantages of using a dry extract are mainly the storage and the stability of the product. When the solid extract is packaged in absence of light and oxygen, the shelf-life of the extract can be significantly prolonged compared to a liquid extract obtained from the same batch of spent hop residue.

Moreover, this invention includes the anti-oxidative agent used for the production of a comestible, which comprises a natural extract obtained from spent hop residue, characterized by being concentrated in stilbenes (e.g. trans-piceid, cis-piceid and trans-resveratrol compounds), and containing no or only trace of polar solvent. The anti-oxidative agent is obtained from spent hop residue, which is the residual fraction generated after the extraction of hop, in whole or in part, of soft resins (e.g. α-acids and β-acids) and hop oils, as it is described in the background of this invention. This invention includes any suitable dry form of the extract, which can be dry formulations such as powder, tab or the like.

Hop components are not stable and most of them are very sensitive to oxidation. The hop acids, the hop oils and the polyphenols gradually degrade during the storage of hops. Likewise, Cantos et al. observed an increase in trans-resveratrol content in grapes stored at 0° C. for 10 days. These authors also mentioned a slight increase in cis-resveratrol isomers. For hop, both forms (cones and pellets T90) were monitored over 12 months of storage. Pellets emerged as the most stable form during the first four months. In both cases, piceid seemed more affected than its aglycon. A possible explanation could be that resveratrol is partially regenerated by the glycoside; this hypothesis needs to be confirmed by additional research.

Surprisingly, the most interesting hop varieties used for the extraction of at least α-acids, β-acids and hop oils, present less interest from a stilbenes point of view. For the extraction of the soft resins, the extract producer will select hop varieties, which are generally rich in α-acids. On the contrary, the stilbenes content will be higher by using hop varieties with a low level of α-acids. This invention is particularly interesting for the valorization of the spent hop material obtained from “aromatic” hop varieties. After the extraction of α-acids, β-acids and hop oils fractions, the residual material contains some other compounds such as cellulose, ash, polyphenols, tannins, proteins, lipids, and some other impurities, which are not extracted during the extraction process. Pellets “type 45” (T45), also called enriched pellets, have a concentration in α-acids, β-acids and hop oils, which is concentrated in 45% of the original hop material, resulting in almost doubling the concentration of active compounds, including stilbenes. The utilization of such type T45, can be an advantageous solution to concentrate the initial content of stilbenes of the hop material before the extraction process, leading to a significant deduction of the amount of impurities (e.g. pesticides, nitrates, heavy metals) in the original hop material, and therefore leading to a more favorable (higher) ratio stilbenes/impurities.

The addition of spent hop material, including both stilbenes and flavanoids can advantageously be done early or/and later during the production process of the production of the comestible. When the addition is early during the production phase, the objective is to protect the comestible through all the following process steps, against oxidation. The stilbenes and flavanoids will be acting as a quencher of the oxygen present during the process production, preserving and improving the quality of the comestible, which will be delivered to the consumer. The quality of the comestible means all characteristics, which provide the visual, the taste, the flavor and the nutritional properties of the comestible. When the addition is later during the production phase, the objective is to protect the comestible from oxidation before the consumption of the comestible by the consumer and to provide to the comestible additional anti-oxidative properties, which are beneficial for the health of the consumer. This invention also relate to a multiple addition in order to combine the different positive effect of the stilbenes, during the production and before the consumption.

It has to be understood that this invention is not limited to a method of producing comestible by adding spent hop material during the production of the comestible, but includes the comestible produced by the described method.

The anti-oxidative agent is advantageously used for the production of a comestible produced by the described method, and can have specific use when the comestible is a food or a beverage such as beer.

### Description of the Preferred Embodiments

This invention covers the method of producing any type of comestible, and is applicable for solid and liquid products, which can be a food or a beverage. A well known beverage, which includes hop in its composition, is beer, and this invention presents a lot of advantages for the fabrication of beer. In a preferred embodiment, this invention describes the method of producing a beverage, such as beer, by adding spent hop material during the production of the beverage, wherein the stilbenes contained in the spent hop material act as quenchers of oxygen during the post addition process, resulting in an improved flavor stability of the beverage, and wherein the surviving stilbenes present in the beverage provide additional anti-oxidative properties to the beverage, leading to health benefits for the consumer. This method is not limited to the brewing industry, but has a lot of application as the spent hop material contains no or very little bittering potential. Therefore, this invention is applicable for any beverage, when the beverage is a fruit or a grain based beverage, which could be a cereal based beverage. This invention is not limited to fermentable products, fermented products, but also covers the products which are subject to any kind of fermentation.

During the production of beer, the hopping rate in the boiling kettle is calculated according to the hop α-acid content, total stilbene contents were compared at the same bitterness potential (relative stilbene concentrations). Surprisingly, the low-bitterness cultivars of this study, here, Willamette, Cascade and Saaz, clearly emerged as the most interesting varieties. It is clear that this invention is not limited to those varieties, which are presented as examples.

During the boiling of the wort, part of the polyphenols are oxidized and generally polymerized to a more complex chemical structure, and therefore are eliminated by precipitation with proteins when the hot break is removed. The precipitated polyphenols are not available anymore to contribute to the reducing power of the wort. Compared to other polyphenols, stilbenes are less subject to precipitation with proteins, and therefore are more present and more available for further reactions. As isomerisation of trans-resveratrol into cis-resveratrol is known to be effective in wine production, both isomers (cis-resveratrol and trans-resveratrol) could be expected in the final beer. However, stronger degradation could also occur in the boiling kettle or after, leading in that case to undetectable amounts in beer. As depicted here, late hopping significantly improves the recovery (7 min at 100° C. allows us to recover 40% resveratrol and 100% piceid). Complementary studies are needed to identify the form most able to be solubilized in wort, to survive the brewing process, and of course, to induce in vivo health benefits.

For the fabrication of beer, the addition of spent hop material in the brewhouse is preferably done by using existing dosing installations. Today, reliable and easy-to-handle automated dosing systems, for hop pellets, as well as for hop extract, have been developed. As yet, no practicable solutions have been found for the automatic dosage of whole hops, in cones. Polyphenols are soluble in polar solvent, including water, and their solubility is positively affected by the temperature. On the contrary, a pre-mature addition will affect negatively the content of stilbenes in the final product. An early addition of spent hop is positive for the solubilization of the stilbenes in the intermediate liquid (e.g. wort), but affects negatively the content in the final product (e.g. beer), due to oxidation degradations, which occur post spent hop addition. A preferred time of addition during the hot process, is very late during the boiling process or after the boiling step before the cooling of the wort. An optimal combination is therefore obtained with a good extraction of stilbenes and limited loses by oxidation.

When there is no possibility to add the spent hop material, including extracts (e.g. liquid and solid extracts), directly during the boiling step, by using an existing dosing system, spent hop material can be added manually to the liquid (e.g. wort, beer). When the solubility of the spent hop material is limited to the liquid, which should be enriched in stilbenes, an alternative could be to use a liquor prepared directly from spent hop material, and to add this liquor to the liquid. The preparation of the liquor can be directly obtainable after a pre-solubilization step of the spent hop material. For this purpose, a polar solvent (e.g. water, ethanol and mixture thereof) can be used, to produce such liquor rich in stilbene compounds.

The spent hop material can be used during the boiling step and/or in any other process step during the production of the produced beverage. When the production of the anti-oxidative beverage comprises a fermentation step, which produces ethanol, it can be advantageous to add the spent hop material during or after the fermentation process. The fermentation phase of the production of a beer is, as explained in the background of this invention, followed by a maturation stage, followed by a “cold ageing”. Adequate time for the addition of spent hop material can be during the transfer from fermentation vessel to cold maturation tank. The ethanol obtained during the fermentation, can be considered as an organic-modifier of the polarity of the produced beverage, and can positively impact on the future stilbenes content, leading to an increase of the extraction yield. When the process of production includes a maturation stage the addition will preferably be done during that phase. The liquid during the maturation phase presents generally the advantages of containing fewer impurities, associated with higher ethanol content, compared to the liquid during the fermentation phase. It is also generally recognized that the maturation occurs at a higher temperature than during the cold ageing. These elements improve the extraction yield of the stilbenes and decrease the stilbene losses, which are in favor of a maturation addition.

For the production of a clear beer, the addition will preferably be done before the final filtration of the beverage. Filtration is an important and critical operation, which should provide the visual aspect and the stability of the delivered beverage to the consumer. At least some of the yeast, protein, cold trub particles and carbohydrate particles have to be removed from the beer to achieve the necessary clarity. Therefore, the filtered beer should be without residual yeast and as bright as possible.

Any degradation of stilbenes and flavanoids, by the presence of dissolved oxygen contained in the beverage or by light exposure, is susceptible to continuing in the packaged product, during the storage life. It is therefore particularly recommandable to store the packaged beverage at a low temperature, preferably up to 4° C., and to avoid as much as possible the exposure of the packaged beverage to light and specifically UV.

Although the preferred embodiments of the invention have been disclosed for illustrative purpose, those skilled in the art will appreciate that various modifications, additions or substitutions are possible, without departing from the scope and spirit of the invention as disclosed in the accompanying claims.

1. A method of manufacturing a comestible product comprising the steps of:
(A) adding a spent hop material to said comestible product; and
quenching oxygen.

2. The method claim 1 wherein said spent hop material is selected from the group consisting of a residual fraction of the hop extraction, in whole or in part, a residual fraction of the soft resins extraction and a residual fraction of the hopoils extraction, a liquid extract of spent hop or a solid extract of spent hop.

3. The method of claim 2, wherein said liquid extract of spent hop comprises stilbene and flavanoid compounds extracted in a liquid phase of an extraction with a polar solvent selected from the group consisting of water, ethanol, isopropanol, methanol, dichloromethane, trichloromethane, n-butanol, ethyl acetate, ethylene dichloride, trichloroethylene, and mixtures thereof.

4. The method of claim 3, wherein said polar solvent is selected from the group consisting of water, ethanol and mixtures thereof.

5. The method of claim 2, wherein said solid extract of spent hop comprises solid residues of said extraction.

6. The method claim 1 wherein the comestible product is a beverage.

7. The method of claim 9 wherein the step of adding said spent hop material is done in a post fermentation process step.

8. The method of claim 1 wherein the hop is selected from the group consisting of hops having a low level of soft resins, pellets produced from hop having a low level of soft resins, enriched type thereof.

9. The method of claim 6 wherein the beverage is a fermented beverage.

10. The method of claim 9 wherein the fermented beverage is a beer.
